(19) United States
(12) Patent Application Publication
(10) Pub. No.: US 2018/0091711 A1
(43) Pub. Date: Mar. 29, 2018

(54) Pair of Eyeglasses with Camera Lenses

(71) Applicant: Wen-Tse Huang, Kaohsiung City (TW)

(72) Inventor: Wen-Tse Huang, Kaohsiung City (TW)

(21) Appl. No.: 15/273,785

(22) Filed: Sep. 23, 2016

(51) Int. Cl. H04N 5/225; G02C 5/14; G02C 11/00; H04N 1/00; H04N 7/18

(52) U.S. Cl. CPC H04N 5/2257; G02C 5/146; H04N 7/183; H04N 5/2254; H04N 1/00209; G02C 11/10

(57) ABSTRACT

A pair of eyeglasses with camera lenses includes a spectacles frame, two temples, and at least one camera module. The camera module includes a rotary lens mount, at least one lens, and a transmission module. The rotary lens mount is pivotally fitted at the spectacles frame or one of the temples and rotatable relative to the glasses frame between a folded position and an unfolded position. The at least one lens installed on the rotary lens mount is used in shooting. The transmission module with the Bluetooth and/or networking functions is used to transmit images shot by the at least one lens to a mobile phone or a tablet device for display or synchronous live network broadcasting.

### BACKGROUND OF THE INVENTION

### 1. Field of the Invention

The present invention relates to a pair of eyeglasses and, more particularly, to a pair of eyeglasses with camera lenses for real-time image recording and transmission.

### 2. Description of the Related Art

In virtue of environmental awareness for energy conservation and carbon emission reduction, the cycling sport becomes a trend popular with the general public. In this regard, bicycles are travel tools of office workers and good partners of cyclists in their leisure lives. Thus, it is a basic requirement of a cyclist to wear protective gears including sports spectacles. In general, a pair of eyeglasses, which includes a spectacles frame, two temples and lenses mounted inside the spectacles frame, is a tool worn in front of a user to correct myopia, hyperopia or presbyopia. Furthermore, a variety of functional glasses such as goggles, sunglasses and polaroid glasses for exercisers, bikers and motorcyclists have been created.

In volatile traffic conditions, a cyclist who wears a pair of auxiliary functional glasses to clearly watch traffic status in front still fails to observe unpredictable risks at the back. Moreover, a cyclist should be aware of traffic status at the back early and respond to them in time for protecting himself/herself. Therefore, a pair of eyeglasses which is worn on a user in the daily life conveniently and further on a cyclist who needs to observe traffic status in the rear will contribute to the cyclist's personal safety.

### BRIEF SUMMARY OF THE INVENTION

Thus, an objective of the present invention is to provide a pair of eyeglasses which can be worn a cyclist for better personal safety with real-time traffic status in front of and behind the cyclist recorded and transmitted to a mobile device.

To achieve this and other objectives, a pair of eyeglasses of the present invention includes a spectacles frame, two temples, and at least one camera module. The spectacles frame has two lateral sides, and each temple includes a front end connected to a corresponding lateral side of the spectacles frame. The camera module includes a rotary lens mount, at least one lens, and a transmission module. The rotary lens mount is pivotally fitted at the spectacles frame or one of the two temples for inward folding or outward stretching relative to the spectacles frame or the temple. The at least one lens is installed on the rotary lens mount and used in shooting. The transmission module has Bluetooth and/or networking functions and is used to transmit images shot by the at least one lens to a mobile phone or a tablet device immediately for display or synchronous live network broadcasting.

The pair of eyeglasses of the present invention is effective in recording images for traffic status in front of and/or behind a user and displaying traffic status in the rear on the screen of a connected electronic device such as a mobile phone or tablet device from which the user is alert of clearest traffic conditions at the back.

In a preferred form, a mounting portion is formed at one of the two lateral sides of the spectacles frame or the front end of the one of the two temples. A containing socket is formed in an external side of the mounting portion. The rotary lens mount is pivotally fitted at the mounting portion and rotatable relative to the glasses frame between a folded position and an unfolded position. The rotary lens mount at the folded position is held inside the containing socket, and the rotary lens mount at the unfolded position stretches outward and forms a specific angle relative to the mounting portion.

In a preferred form, the mounting portion extends inward from each of the lateral sides of the spectacles frame. The at least one lens includes front and rear lenses respectively installed on external and internal surfaces of the rotary lens mount.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is a perspective view of a pair of eyeglasses with camera lenses of the present invention.

FIG. 2 is a schematic view which illustrates a rotary lens mount of the pair of eyeglasses in FIG. 1 stretches outward to shoot images in front.

FIG. 3 is a schematic view which illustrates the rotary lens mount of the pair of eyeglasses in FIG. 1 stretches outward to shoot images in the rear.

FIG. 4 is a schematic view which illustrates the pair of eyeglasses in FIG. 1 is worn on a user.

### DETAILED DESCRIPTION OF THE INVENTION

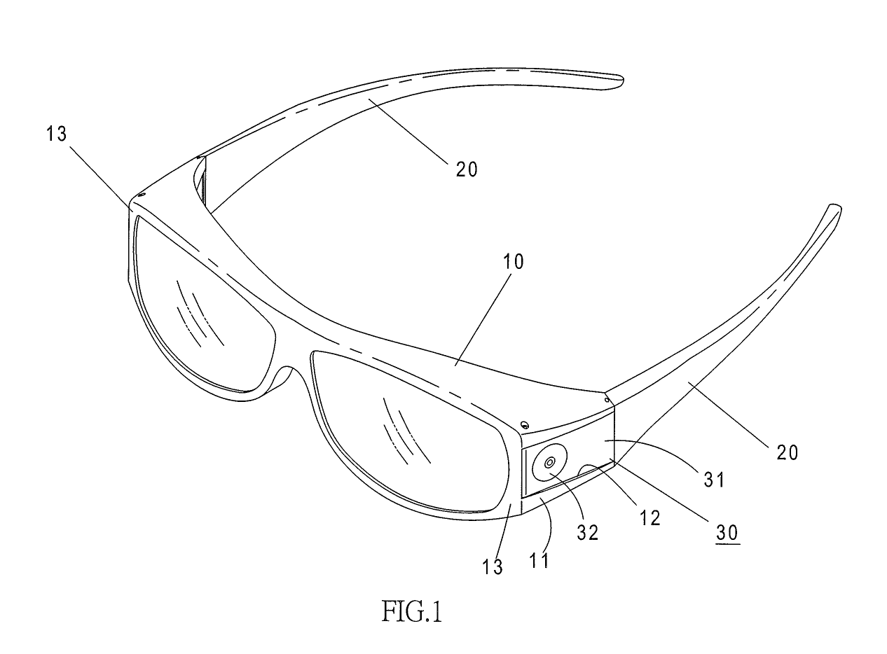

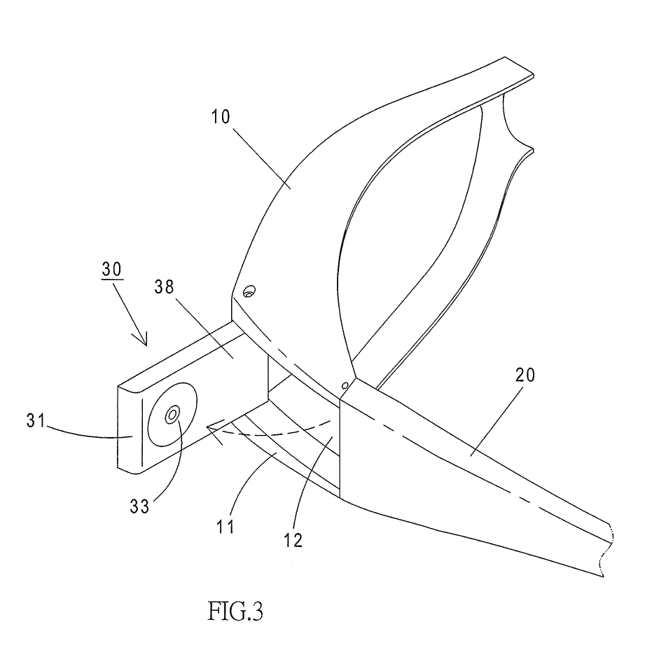

A pair of eyeglasses according to an embodiment of the present invention is shown in FIGS. 1 through 4 of the drawings and generally includes a spectacles frame 10, two temples 20, and at least one camera module 30. The spectacles frame 10 has two lateral sides 13. A mounting portion 11 extends inward from each lateral side 13 and features a larger area for development of a containing socket 12 in an external side of the mounting portion 11. A front end of each temple 20 is pivotally connected to a corresponding mounting portion 11, so that each temple 20 is rotatable relative to the glasses frame 10 for a pair of collapsible eyeglasses.

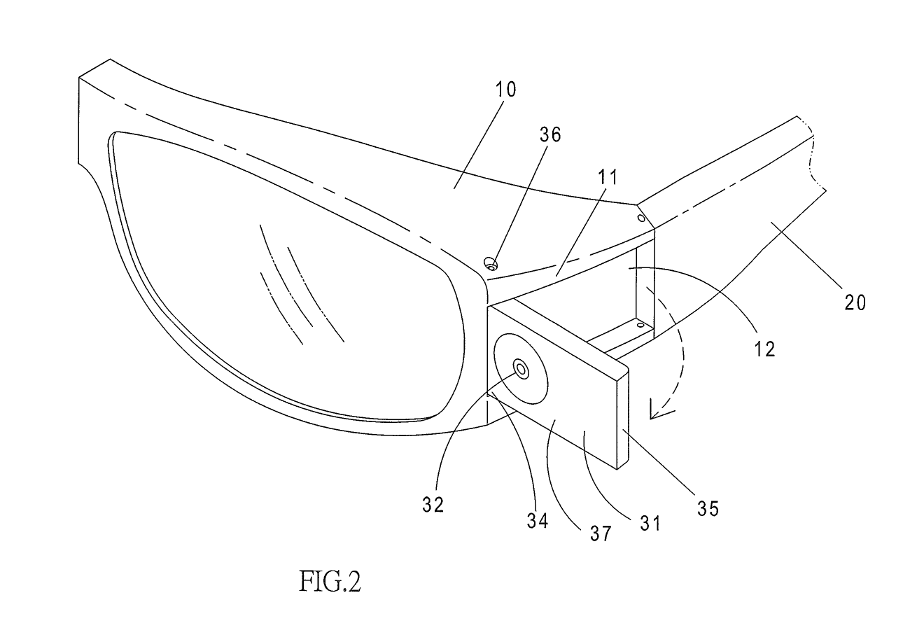

In this embodiment, the spectacles frame 10 is laterally provided with two camera modules 30 at the lateral sides 13 thereof, respectively. Each camera module 30 includes a rotary lens mount 31, a front lens 32, and a rear lens 33. The rotary lens mount 31 includes a first end 34 and a second end 35 opposite to the first end 34. The rotary lens mount 31 is integrated with the glasses frame 10 when a front end of the mounting portion 11 and the first end 34 of the rotary lens mount 31 are penetrated by a pivot 36, so that the rotary lens mount 31 is rotatable relative to the glasses frame 10 between a folded position and an unfolded position about an axis defined by the pivot 36. In the folded position, the rotary lens mount 31 is held in the containing socket 12 (FIG. 1). In the unfolded position, the rotary lens mount 31 stretches outward and forms an approximate right angle relative to the mounting portion 11 (FIG. 2). The front and rear lenses 32 and 33 are installed on an external surface 37 and an internal surface 38 of the rotary lens mount 31, respectively. The front lens 32 and the rear lens 33 respectively faces a user's front side and rear side when the rotary lens mount 31 is moved to the unfolded position. The camera module 30 further includes electronic components such as power supply component, control component, memory component and switch (not shown in figures) on the spectacles frame 10 and/or the temples 20. The electronic components are electronically connected to one another for image recording through the front and rear lenses 32 and 33. The camera module 30 further includes a transmission module (not shown in figures) and is characteristic of Bluetooth and/or networking functions for real-time image transmission to and display on a mobile phone or a tablet device (Bluetooth function) and for a synchronous live network broadcasting (networking function).

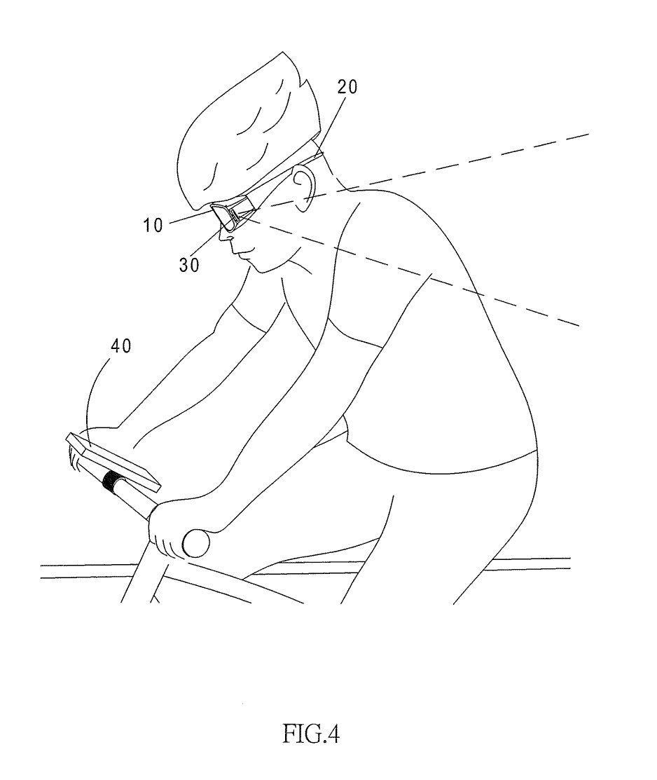

In practice, when the camera modules 30 are not used, the pair of eyeglasses of the present invention features the rotary lens mounts 31 held inside the containing sockets 12 and is similar to a pair of ordinary eyeglasses in appearance and functionally. As such, the front and rear lenses 32 and 33 of the pair of eyeglasses is undetected by other persons for less doubt of violating privacy. A user who prefers a driving recording or network broadcasting function through the camera modules 30 should rotate the rotary lens mounts 31 relative to the spectacles frame 10 and extract the rotary lens mounts 31 from the containing sockets 12, allowing each rotary lens mount 31 to be formed an approximate right angle relative to the corresponding temple 20, so that the front lens 32 and the rear lens 33 of each camera module 30 with functions of recording traffic status in front of and behind a user faces a front side and a rear side, respectively. Moreover, each rotary lens mount 31 is adjustably and conveniently rotated to a specific angle by the user as required for a camera lens' better camera angle. Referring to FIG. 4 for applications of a connected electronic device 40 such as mobile phone or tablet device, traffic status at the back shot by the rear lens 33 is transmitted to the electronic device 40 and displayed on a screen of the electronic device 40 from which a cyclist is alert to clearest traffic status without turning round. In addition, a further function is provided by the pair of eyeglasses of the present invention with abundant image data synchronously shared on the Internet due to the network broadcasting function.

In this embodiment, the mounting portions 11 are formed on the spectacles frame 10, and each temple 20 allows its front end to be moveably connected to a corresponding mounting portion 11. In a feasible embodiment, the mounting portions 11 with the containing sockets 12 are respectively designed on the front ends of the temples 20, so that the rotary lens mount 31 of each camera module 30 is accommodated in one of the temples 20. Furthermore, the camera module 30 may include only one of the front and rear lenses 32 and 33.

The scope of the invention is to be indicated by the appended claims, rather than by the foregoing description, and all changes which come within the meaning and range of equivalency of the claims are intended to be embraced therein.

1. A pair of eyeglasses comprising:
a spectacles frame having two lateral sides;
two temples each including a front end connected to a corresponding lateral side of the spectacles frame; and
a camera module including a rotary lens mount, at least one lens, and a transmission module, with the rotary lens mount pivotally fitted at the spectacles frame or one of the two temples, with the at least one lens installed on the rotary lens mount and used in shooting, with the transmission module having Bluetooth and/or networking functions and used to transmit images shot by the at least one lens to a mobile phone or a tablet device immediately for display or synchronous live network broadcasting.

2. The pair of eyeglasses according to claim 1, wherein a mounting portion formed at one of the two lateral sides of the spectacles frame or the front end of the one of the two temples, with a containing socket formed in an external side of the mounting portion, with the rotary lens mount pivotally fitted at the mounting portion and being rotatable relative to the glasses frame between a folded position and an unfolded position, wherein the rotary lens mount at the folded position is held inside the containing socket, and wherein the rotary lens mount at the unfolded position stretches outward and forms a specific angle relative to the mounting portion.

3. The pair of eyeglasses according to claim 2, wherein the mounting portion extends inward from the one of the two lateral sides of the spectacles frame.

4. The pair of eyeglasses according to claim 1, wherein the at least one lens includes front and rear lenses respectively installed on an external surface and an internal surface of the rotary lens mount.
